(19) United States
(12) Patent Application Publication
(10) Pub. No.: US 2023/0422274 A1
(43) Pub. Date: Dec. 28, 2023

(54) RESOURCE ALLOCATION FOR MULTI-TRP SIDELINK COMMUNICATION

(71) Applicant: QUALCOMM Incorporated, San Diego, CA (US)

(72) Inventors: Shuanshuan WU, San Diego, CA (US); Kapil GULATI, Belle Mead, NJ (US); Sourjya DUTTA, San Diego, CA (US); Junyi LI, Fairless Hills, PA (US); Hui GUO, Beijing (CN); Anantharaman BALASUBRAMANIAN, San Diego, CA (US)

(21) Appl. No.: 18/037,758

(22) PCT Filed: Jan. 26, 2021
(86) PCT No.: PCT/CN2021/073786

§ 371 Date: May 18, 2023

(51) Int. Cl. H04W 72/25; H04W 24/08; H04B 17/318; H04L 5/00; H04W 72/542

(52) U.S. Cl. CPC H04W 72/25; H04W 24/08; H04B 17/328; H04L 5/0035; H04W 72/542

(57) ABSTRACT

Apparatus, methods, and computer program products for resource allocation for multi-TRP sidelink communication are provided. An example method includes receiving one or more signals comprising sidelink control information (SCI) at multiple TRPs of the sidelink device, the SCI indicating a resource reservation. The example method further includes decoding the SCI based on the one or more signals measuring a reference signal received power (RSRP) associated with the SCI at each of the multiple TRPs. The example method further includes. The example method further includes determining available resources for sidelink transmission for a subset of one or more of the multiple TRPs based on the RSRP.

### BACKGROUND

### Technical Field

The present disclosure relates generally to communication systems, and more particularly, to sidelink communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. Some aspects of wireless communication may comprise direct communication between devices based on sidelink, such as in vehicle-to-everything (V2X) and/or other device-to-device (D2D) communication. There exists a need for further improvements in sidelink technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. An example method may include receiving one or more signals comprising sidelink control information (SCI) at multiple TRPs of the sidelink device, the SCI indicating a resource reservation. The example method further includes decoding the SCI based on the one or more signals measuring a reference signal received power (RSRP) associated with the SCI at each of the multiple TRPs. The example method further includes. The example method further includes determining available resources for sidelink transmission for a subset of one or more of the multiple TRPs based on the RSRP.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network including sidelink communication.

FIG. 2 illustrates example aspects of a sidelink slot structure.

FIG. 3 is a diagram illustrating an example of a first device and a second device involved in wireless communication based, e.g., on sidelink.

FIG. 4A is a diagram illustrating examples of sidelink devices having multiple TRP s.

FIG. 4B is a diagram illustrating the common processing and the separate processing for multiple TRPs of a sidelink device.

FIG. 5 illustrates an example of a sensing and reservation procedure for sidelink resource communication.

FIGS. 6A and 6B illustrate examples of full-duplex communication.

FIG. 7 illustrates examples of in-band full duplex (IBFD) resources and sub-band frequency division duplex (FDD) resources for full duplex communication.

FIG. 8 illustrates an example of available resources for a sidelink device having multiple TRPs.

FIG. 9 illustrates an example of resource selection based on available resources for a sidelink device having multiple TRPs.

FIG. 10 is a flowchart of a method of wireless communication.

FIG. 11 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

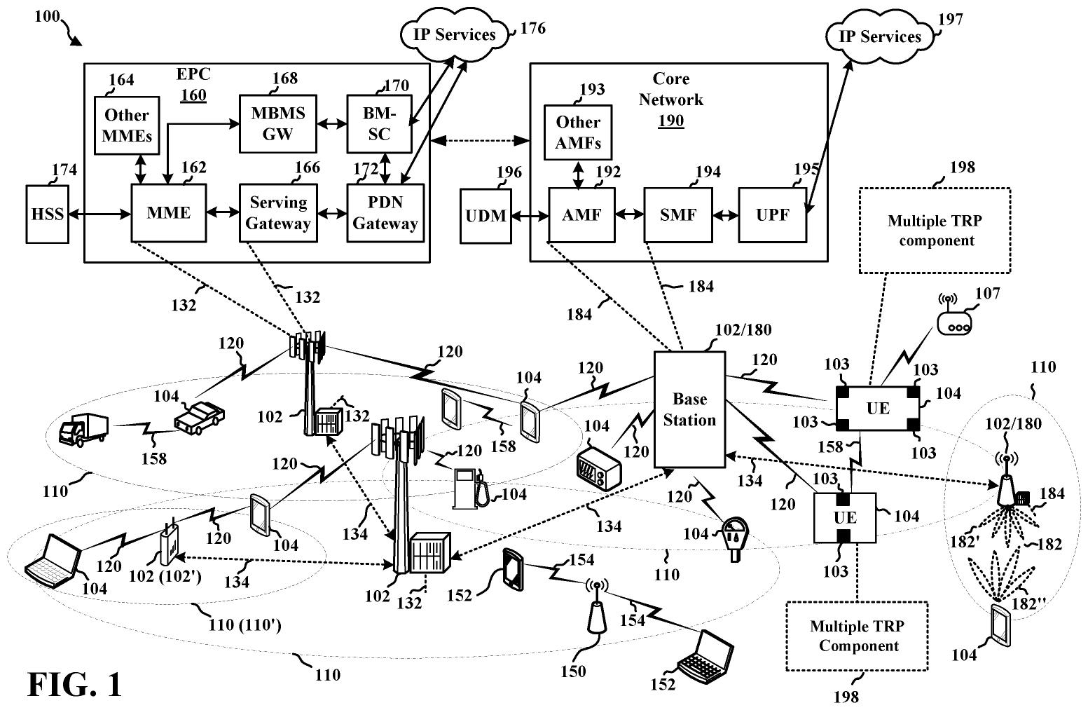

FIG. 1 is a diagram illustrating an example of a wireless communications system and an access network 100 including base stations 102 and 180 and UEs 104. A link between a UE 104 and a base station 102 or 180 may be established as an access link, e.g., using a Uu interface. Other communication may be exchanged between wireless devices based on sidelink. For example, some UEs 104 may communicate with each other directly using a device-to-device (D2D) communication link 158. Some examples of sidelink communication may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as abase station), vehicle-to-pedestrian (V2P), cellular vehicle-to-everything (C-V2X), and/or a combination thereof and/or with other devices, which can be collectively referred to as vehicle-to-anything (V2X) communications. Sidelink communication may be based on V2X or other D2D communication, such as Proximity Services (ProSe), etc.

A sidelink device may include multiple transmitter-receiver points (TRPs). For example, a vehicle may have multiple antenna panels, such as a front antenna panel and a rear antenna panel. Larger vehicles may have more than two TRPs. Although examples are provided for vehicular sidelink communication, the aspects presented here are applicable to non-vehicular sidelink devices and are not limited to a vehicle application. FIG. 1 illustrates UEs 104 having multiple TRPs 103. TRPs are different radio frequency (RF) modules having a shared hardware and/or software controller. A UE 104 may schedule sidelink communication per TRP 103. In some examples, the UE 104 may be capable of concurrent communication via the multiple TRPs 103, e.g., communication via different TRPs that overlaps in time. For example, the UE 104 may transmit a first transmission via a first TRP that overlaps in time, at least partially, with a second transmission via a second TRP. In some examples, the UE 104 may be capable of full-duplex communication in which the UE transmits via one TRP concurrently with reception via a second TRP. For example, a UE may transmit a sidelink transmission via a front antenna panel while receiving sidelink communication via a rear antenna panel.

In a first sidelink resource allocation mode, a UE may receive a resource allocation for sidelink communication from a central entity, such as a base station 102 or 180. The sidelink resource allocation from a base station may be referred to as “resource allocation mode 1” or a “centralized” resource allocation mode, e.g., in which a network entity allocates sidelink resources for multiple sidelink devices. In a second resource allocation mode, a UE 104 may autonomously determine resources for sidelink transmissions by sensing, or monitoring, for reservations of other sidelink devices. The autonomous resource selection may be referred to as “resource allocation mode 2,” a “decentralized” resource allocation mode, or a sensing based sidelink resource allocation mode, e.g., where each sidelink device selects its own sidelink resources for sidelink transmissions. In the decentralized sidelink resource allocation mode, rather than receiving an allocation of sidelink resources from a network entity, a UE 104 may determine the sidelink transmission resource(s) based on a sensing and resource reservation procedure. The decentralized resource allocation may not address the potential for transmissions from multiple TRPs 103.

Aspects presented herein enable resource allocation that enables a determination of sidelink candidate resources per TRP. For example, a UE 104, or another device communicating based on sidelink, may include a multiple TRP component 198 configured to receive one or more signals comprising sidelink control information (SCI) at multiple TRPs of the sidelink device, the SCI indicating a resource reservation. The multiple TRP component 198 may be further configured to decode the SCI based on the one or more signals. The multiple TRP component 198 may be further configured to measure a reference signal received power (RSRP) associated with the SCI at each of the multiple TRPs. The multiple TRP component 198 may be further configured to determine available resources for sidelink transmission for a subset of one or more of the multiple TRPs based on the RSRP. The aspects presented herein may enable per TRP sidelink resource determination, or resource exclusion, which may facilitate the flexible scheduling of multiple TRP transmissions. The flexible scheduling of multiple TRP transmissions based on the improved resource selection presented herein may increase sidelink system capacity or may reduce interference in multiple TRP sidelink communication, such as multiple TRP V2X communication.

In some examples, the D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

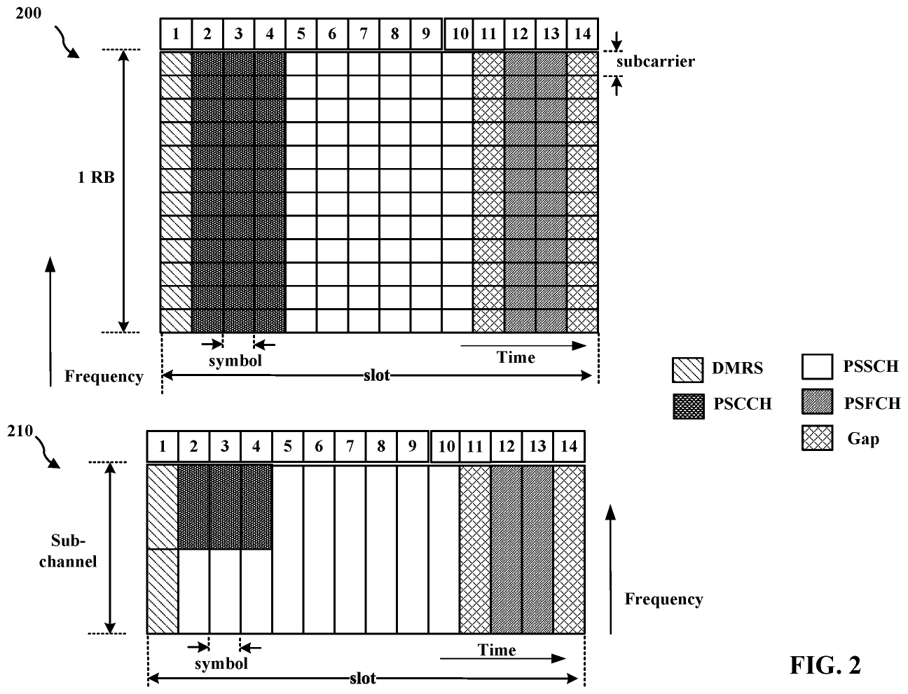

In addition to UEs, sidelink communication may also be transmitted and received by other transmitting and receiving devices, such as Road Side Unit (RSU) 107, etc. Sidelink communication may be exchanged using a PC5 interface, such as described in connection with the example in FIG. 2. Although the following description, including the example slot structure of FIG. 2, may provide examples for sidelink communication in connection with 5G NR, the concepts described herein may be applicable to other similar areas, such as LTE, LTE-A, CDMA, GSM, and other wireless technologies.

The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming. Similarly, beamforming may be applied for sidelink communication, e.g., between UEs.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same. Although this example is described for the base station 180 and UE 104, the aspects may be similarly applied between a first and second device (e.g., a first and second UE) for sidelink communication.

The EPC 160 may include a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

FIG. 2 includes diagrams 200 and 210 illustrating example aspects of slot structures that may be used for sidelink communication (e.g., between UEs 104, RSU 107, etc.). The slot structure may be within a 5G/NR frame structure in some examples. In other examples, the slot structure may be within an LTE frame structure. Although the following description may be focused on 5G NR, the concepts described herein may be applicable to other similar areas, such as LTE, LTE-A, CDMA, GSM, and other wireless technologies. The example slot structure in FIG. 2 is merely one example, and other sidelink communication may have a different frame structure and/or different channels for sidelink communication. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. Diagram 200 illustrates a single resource block of a single slot transmission, e.g., which may correspond to a 0.5 ms transmission time interval (TTI). A physical sidelink control channel may be configured to occupy multiple physical resource blocks (PRBs), e.g., 10, 12, 15, 20, or 25 PRBs. The PSCCH may be limited to a single sub-channel. A PSCCH duration may be configured to be 2 symbols or 3 symbols, for example. A sub-channel may comprise 10, 15, 20, 25, 50, 75, or 100 PRBs, for example. The resources for a sidelink transmission may be selected from a resource pool including one or more subchannels. As a non-limiting example, the resource pool may include between 1-27 subchannels. A PSCCH size may be established for a resource pool, e.g., as between 10-100% of one subchannel for a duration of 2 symbols or 3 symbols. The diagram 210 in FIG. 2 illustrates an example in which the PSCCH occupies about 50% of a subchannel, as one example to illustrate the concept of PSCCH occupying a portion of a subchannel. The physical sidelink shared channel (PSSCH) occupies at least one subchannel. The PSCCH may include a first portion of sidelink control information (SCI), and the PSSCH may include a second portion of SCI in some examples.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 2, some of the REs may comprise control information in PSCCH and some Res may comprise demodulation RS (DMRS). At least one symbol may be used for feedback. FIG. 2 illustrates examples with two symbols for a physical sidelink feedback channel (PSFCH) with adjacent gap symbols. A symbol prior to and/or after the feedback may be used for turnaround between reception of data and transmission of the feedback. The gap enables a device to switch from operating as a transmitting device to prepare to operate as a receiving device, e.g., in the following slot. Data may be transmitted in the remaining REs, as illustrated. The data may comprise the data message described herein. The position of any of the data, DMRS, SCI, feedback, gap symbols, and/or LBT symbols may be different than the example illustrated in FIG. 2. Multiple slots may be aggregated together in some examples.

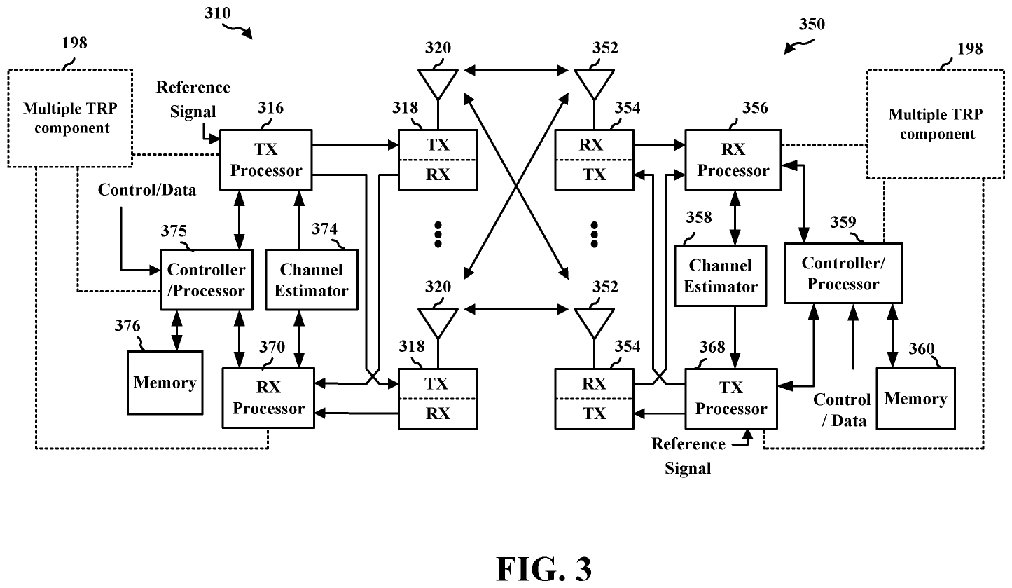

FIG. 3 is a block diagram 300 of a first wireless communication device 310 in communication with a second wireless communication device 350 based on sidelink. In some examples, the devices 310 and 350 may communicate based on V2X or other D2D communication. The communication may be based on sidelink using a PC5 interface. The devices 310 and the 350 may comprise a UE, an RSU, a base station, etc. Packets may be provided to a controller/processor 375 that implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the device 350. Each spatial stream may then be provided to a different antenna 320 via a separate transmitter 318TX. Each transmitter 318TX may modulate an RF carrier with a respective spatial stream for transmission.

At the device 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the device 350. If multiple spatial streams are destined for the device 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by device 310. These soft decisions may be based on channel estimates computed by the channel estimator 358. The soft decisions are then decoded and deinterleaved to recover the data and control signals that were originally transmitted by device 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. The controller/processor 359 may provide demultiplexing between transport and logical channels, packet reassembly, deciphering, header decompression, and control signal processing. The controller/processor 359 is also responsible for error detection using an ACK and/or NACK protocol to support HARQ operations.

Similar to the functionality described in connection with the transmission by device 310, the controller/processor 359 may provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

Channel estimates derived by a channel estimator 358 from a reference signal or feedback transmitted by device 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The transmission is processed at the device 310 in a manner similar to that described in connection with the receiver function at the device 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. The controller/processor 375 provides demultiplexing between transport and logical channels, packet reassembly, deciphering, header decompression, control signal processing. The controller/processor 375 is also responsible for error detection using an ACK and/or NACK protocol to support HARQ operations.

As illustrated in FIG. 3, at least one of the TX processor 316 or 368, the RX processor 356 or 370, and the controller/processor 359 or 375 may be configured to perform aspects in connection with the multiple TRP component 198 of FIG. 1.

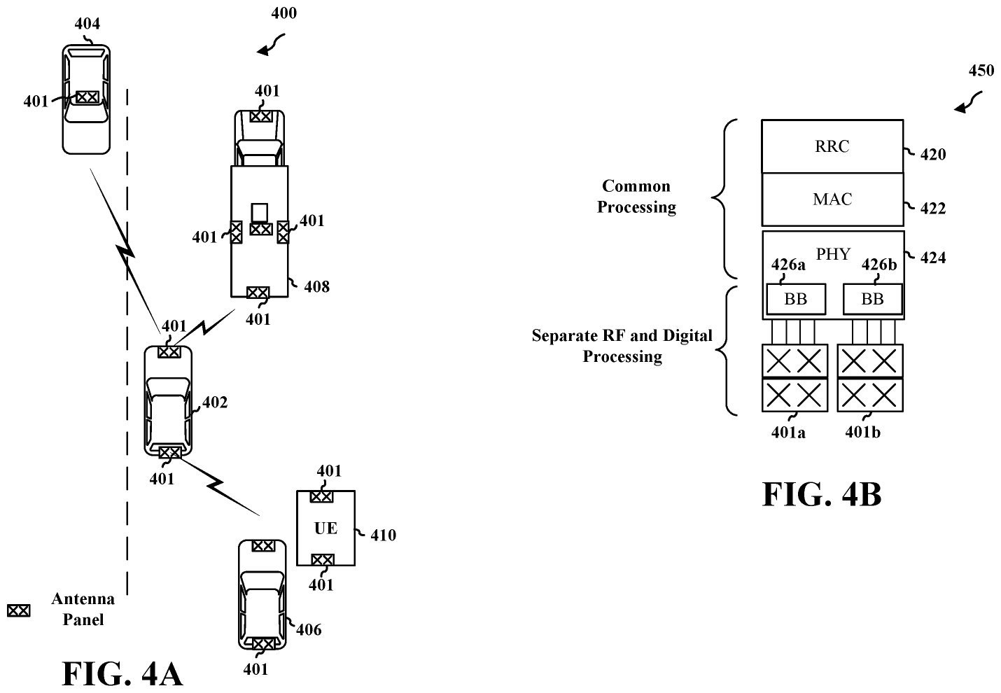

A sidelink device may include multiple TRPs. For example, a vehicle may have multiple antenna panels, such as a front antenna panel and a rear antenna panel. Larger vehicles may have more than two TRPs. FIG. 4A is a diagram 400 showing an example with UEs 402, 406, and 410 having two TRPs 401, e.g., a front antenna panel and a rear antenna panel FIG. 4A also illustrates a UE 408 associated a larger vehicle having more than two TRPs 401, as well as a UE 404 having a single TRP 401. Although examples are provided for vehicular sidelink communication to illustrate the concept, the aspects presented here are applicable to non-vehicular sidelink devices and are not limited to a vehicle application. For example, the UE 410 may be a non-vehicular UE.

Each TRP comprises different RF modules having a shared hardware and/or software controller. FIG. 4B illustrates a diagram 450 showing the processing at the RRC layer 420, MAC layer 422, and part of the PHY layer 424 for multiple TRPs 401a and 401b that is common to both TRP 401a and TRP 401b. FIG. 4B illustrates that each TRP may have separate RF and digital processing. Each TRP may perform separate baseband processing 426a and 426b. Each TRP may comprise a different antenna panel or a different set of antenna elements (e.g., 401a and 401b) of a sidelink device. The TRPs of the sidelink device may be physically separated. For example, TRPs on a vehicle may be located at different locations of the vehicle. As an example, front and rear antenna panels on a vehicle may be separated by 3 meters, 4 meters, etc. The spacing between TRPs may vary based on the size of a vehicle and/or the number of TRPs associated with the vehicle. Each of the TRPs may experience a channel differently (e.g., experience a different channel quality) due to the difference physical location, the distance between the TRPs, different line-of-sight (LOS) characteristics (e.g., a LOS channel in comparison to a non-LOS (NLOS) channel), blocking/obstructions, interference from other transmissions, among other reasons.

A sidelink device may schedule sidelink communication per TRP 401. As an example, a UE may schedule a V2X transmission for transmission from a particular TRP of a vehicle. In some examples, the sidelink device may be capable of concurrent communication via the multiple TRPs, e.g., communication via different TRPs that overlaps in time. For example, the UE 402 may transmit a first transmission (e.g., a first sidelink TB) via the front TRP 401 that overlaps in time, at least partially, with a second transmission (e.g., a second sidelink TB) via the rear TRP 401. The concurrent transmissions of the two TBs may be in the same resources or overlapping resources. In other examples, a sidelink device may transmit a particular TB using one TRP or a subset of a larger group of TRPs. For example, the UE 408 is illustrated as having five TRPs 401 and may transmit a TB using a single TRP. Alternately, the UE 408 may transmit a TB using a subset of the five TRPs, e.g., two, three, or four TRPs.

A sidelink device, such as a UE, may autonomously determine resources for sidelink transmissions by sensing, or monitoring, for reservations of other sidelink devices. The autonomous resource selection may be referred to as “resource allocation mode 2,” a “decentralized” resource allocation mode, or a sensing based sidelink resource allocation mode, e.g., where each sidelink device selects its own sidelink resources for sidelink transmissions. In contrast to a centralized resource allocation mode (e.g., resource allocation mode 1) in which a network entity may assign sidelink resources, in the decentralized sidelink resource allocation mode, a UE may autonomously select sidelink transmission resources based on a sensing and resource reservation procedure.

When a sidelink device, such as a UE, is preparing to transmit data, the sidelink device may select transmission resources from a candidate resource set from which previously reserved resources are excluded. In order to maintain the candidate resource set, the sidelink device may monitor for resource reservations from other sidelink devices. For example, the sidelink device may receive SCI from other UEs including reservation information in a resource reservation field. The number of resources (e.g., sub-channels per subframe) reserved by a UE may depend on the size of data to be transmitted by the UE. Although the example is described for a UE receiving reservations from another UE, the reservations may also be received from an RSU or other device communicating based on sidelink. The sidelink device may exclude resources that are used and/or reserved by the other UEs from a candidate resource set. The exclusion of the reserved resources enables the UE to select/reserve resources for a transmission from the resources that are unused/unreserved. Although the example is described for a UE receiving reservations from another UE, the reservations may also be received from an RSU or other device communicating based on sidelink.

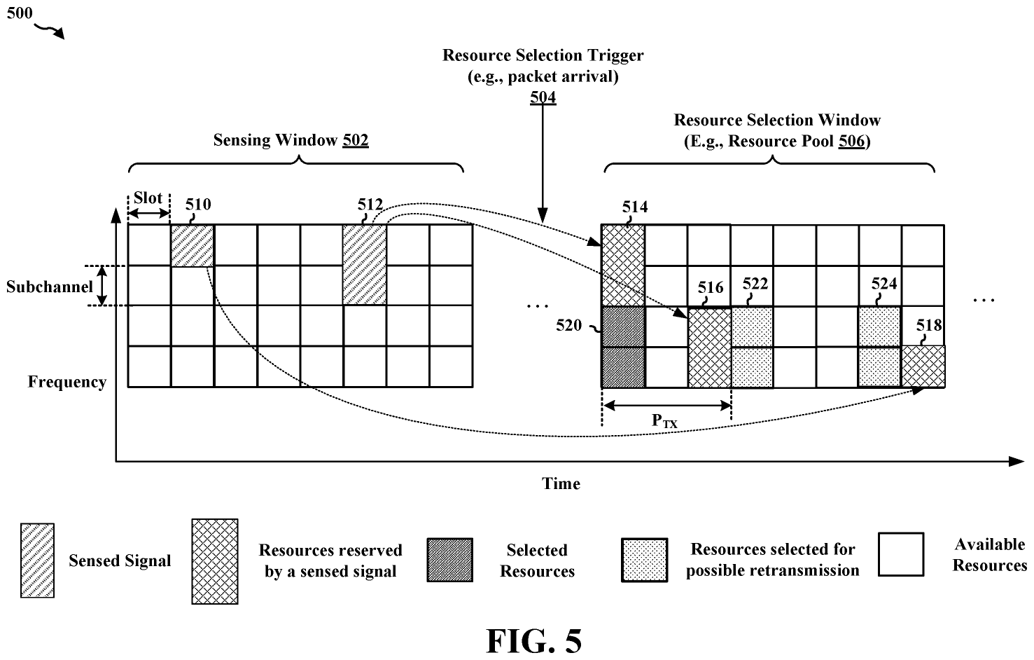

FIG. 5 is a diagram 500 showing time-frequency resources for sidelink sensing and resource selection, e.g., mode 2 resource allocation. FIG. 5 shows reservations 510 and 512 for sidelink transmissions. The resource reservations for each UE may be in units of one or more sub-channels in the frequency domain (e.g., sub-channels 1 to 4), and may be based on one slot in the time domain. A UE may use resources in a first slot to perform an initial transmission, and may reserve resources in one or more future slots, e.g., for retransmissions. In some examples, up to two different future slots may be reserved by a particular UE for retransmissions. The reserved resource may be used for a retransmission of a packet or for transmission of a different packet. For example, the reservation may be for two retransmissions or for more than two retransmissions. The reservation may be for an initial transmission and a single transmission. The reservation may be for an initial transmission. The resource reservation may be chained, e.g., with a transmission A indicating a resource for transmission B. Transmission B may then indicate a resource for transmission C, and transmission C may indicate a resource for transmission D. The pattern may continue with transmission D indicating future resources. In another example, transmission A may indicate resources for transmissions B and C. Then, transmission B may indicate resources for transmissions C and D. The pattern may continue with transmission D indicating future resources.

A sidelink device may identify available resources in a future resource selection window 506 by monitoring for resource reservations during a sensing window 502. The sensing window may be based on a range of slots and sub-channels. FIG. 5 illustrates an example sensing window including 8 consecutive time slots and 4 consecutive sub-channels, which spans 32 resource blocks. The sidelink device may monitor resources of a sidelink resource pool, over the slots of the sensing window. FIG. 5 illustrates that sidelink transmission 510 indicates a resource reservation for resource 518, and sidelink transmission 512 indicates a resource reservation for resources 514 and 522. For example, the sidelink transmissions 510 and 512 may each include SCI that indicates the corresponding resource reservation.

A sidelink device receiving the transmissions 510 and 512 may exclude the resources 514, 516, and 518 as candidate resources in a candidate resource set based on the resource selection window 506. In some examples, the sidelink device may exclude the resources 514, 516, or 518 based on whether a measured RSRP for the received SCI (e.g., in 510 or 512) meets a threshold. When a resource selection trigger occurs at 504, such as the sidelink device having a packet for sidelink transmission, the sidelink device may select resources for the sidelink transmission (e.g., including PSCCH and/or PSSCH) from the remaining resources of the resource pool within the resource selection window 506 after the exclusion of the reserved resources (e.g., 514, 516, and 518). FIG. 5 illustrates an example in which the sidelink device selects the resource 520 for sidelink transmission. The sidelink device may also select resources 522 and/or 524 for a possible retransmission. After selecting the resources for transmission, the sidelink device may transmit SCI indicating a reservation of the selected resources. Thus, each sidelink device may use the sensing/reservation procedure to select resources for sidelink transmissions from the available candidate resources that have not been reserved by other sidelink devices.

A sidelink device may support full-duplex sidelink communication via multiple TRPs. For example, the UE 402 in FIG. 4A may transmit a sidelink transmission via the front antenna panel at an overlapping time with reception of sidelink communication via the rear antenna panel.

Full duplex operation in which a wireless device concurrently transmits and receives communication that overlaps in time may enable more efficient use of the wireless spectrum. Full duplex operation may include simultaneous transmission and reception in a same frequency range, or partially overlapped frequency range, or separate frequency ranges.

For example, a UE, or other sidelink device, may transmit communication from one antenna panel and may receive communication with another antenna panel. For example, the sidelink device may transmit from one TRP concurrently with reception at another TRP. As an example, the UE may transmit a sidelink transmission from a TRP at the front of a vehicle and may concurrently receive via a TRP at the rear of the vehicle. As another example, the sidelink device may perform full-duplex communication from the same antenna panel. For example, the sidelink device may receive sidelink communication using a first set of one or more antenna elements within the antenna panel while concurrently using a second set of one or more antenna elements of the antenna panel to transmit a sidelink transmission. In some examples, the full duplex communication may be conditional on beam or spatial separation or other conditions. Full duplex communication may reduce latency. Full duplex communication may improve spectrum efficiency, e.g., spectrum efficiency per UE, with respect to the spectral efficiency of half-duplex communication that supports transmission or reception of information in one direction at a time without overlapping uplink and downlink communication. Full duplex communication may enable more efficient use of wireless resources.

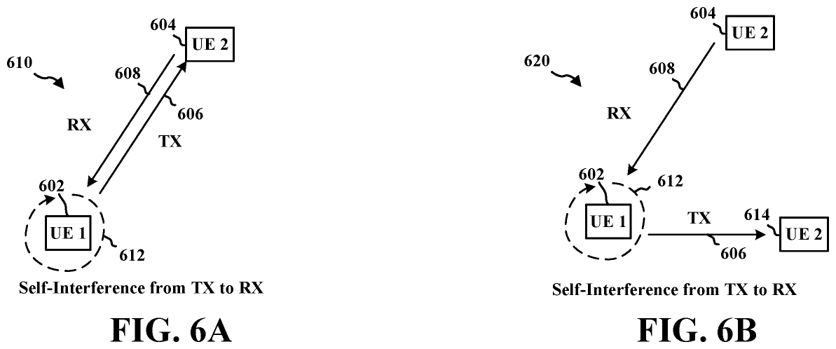

Due to the simultaneous Tx/Rx nature of full duplex communication, a sidelink device may experience self-interference caused by signal leakage from its transmitting TRP to its receiving TRP or from a transmitting set of one or more antenna elements to a receiving set of one or more antenna elements. In addition, the sidelink device may also experience interference from other devices, such as transmissions from a second sidelink device. Such interference (e.g., self-interference or interference caused by other devices) may impact the quality of the communication, or even lead to a loss of information. FIG. 6A illustrates an example of full-duplex communication 610 in which a UE 602 concurrently transmits and receives communication with a second UE 604. FIG. 6A illustrates that the transmission of signal 606 from UE 602 may cause interference 612 to the reception of the signal 608 from the second UE 604. FIG. 6B illustrates an example of full-duplex communication 620 in which the UE 602 transmits a signal 606 to the UE 614 concurrently with reception of a signal 608 from the UE 604. Similar to the example in FIG. 6A, FIG. 6B illustrates that the transmission of the signal 606 may be received by the receiving TRP or receiving antenna elements and cause self-interference 612 to the concurrent reception of the signal 608.

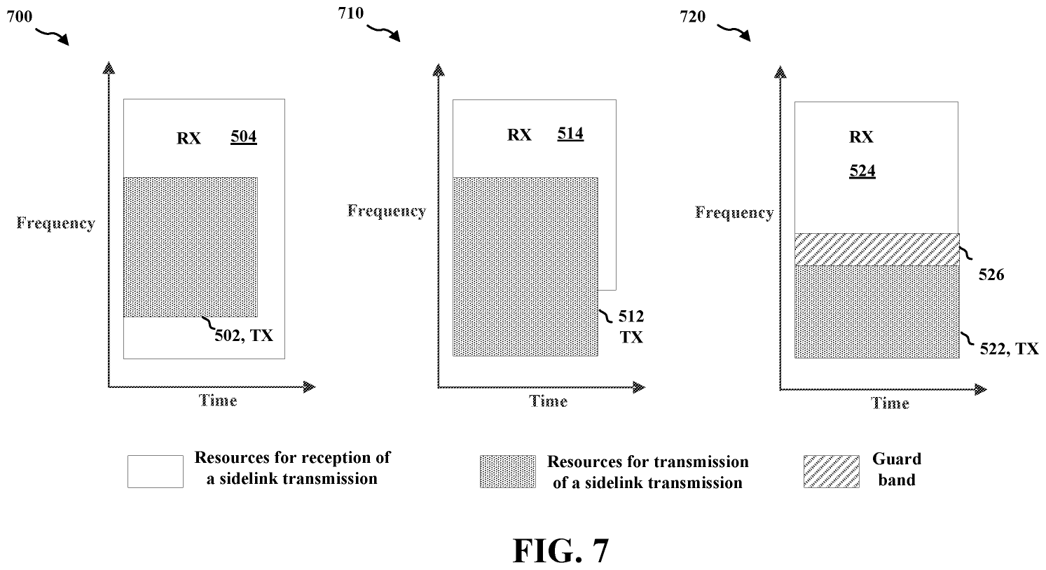

Full duplex communication may be in a same frequency band. The transmitted and received communication may be in different frequency subbands, in the same frequency subband, or in partially overlapping frequency subbands. FIG. 7 illustrate a first example 700 and a second example 710 of in-band full duplex (IBFD) resources (which may also be referred to as single-frequency full-duplex) and a third example 720 of sub-band full-duplex resources. In IBFD, signals may be transmitted and received in overlapping times and overlapping in frequency. As shown in the first example 700, a time and a frequency allocation of transmission resources 702 may fully overlap with a time and a frequency allocation of reception resources 704. In the second example 710, a time and a frequency allocation of transmission resources 712 may partially overlap with a time and a frequency of allocation of reception resources 714.

IBFD is in contrast to sub-band frequency division duplex (FDD), where transmission and reception resources may overlap in time using different frequencies, as shown in the third example 720. In the third example 720, the transmission resources 722 are separated from the reception resources 724 by a guard band 726. The guard band may be frequency resources, or a gap in frequency resources, provided between the transmission resources 722 and the reception resources 724. Separating the frequency resources for transmission and reception with a guard band may help to reduce self-interference. Transmission and reception resources that are immediately adjacent to each other may be considered as having a guard band width of 0. As an output signal, e.g., from a UE transmitter may extends outside the transmission resources, the guard band may reduce interference experienced by the UE. Sub-band FDD may also be referred to as “flexible duplex”.

As previously described, a sidelink device may schedule sidelink communication per TRP 401. As an example, a sidelink device may schedule a V2X transmission for transmission from a particular TRP of a vehicle. Depending on the radio link interference/channel quality, only part of TRPs may be activated in a transmission. For example, a sidelink device may be transmitting a TB using only front TRP. In another example, with per-TRP scheduling enabled, a sidelink device may transmit to another sidelink device using a first set of TRPs while transmitting to one additional sidelink device using a second set of TRPs. The two transmissions may take place in the same/overlapping time/frequency resource without interfering with each other. In some communication systems, available resource determination is not optimal for multi-TRP operation given that the maximum RSRP from multiple TRPs will be reported for a resource. For example, in some communication systems, a resource may be identified as available only if it is available from all TRP RSRP measurement, which may limit the capacity of per-TRP scheduling.

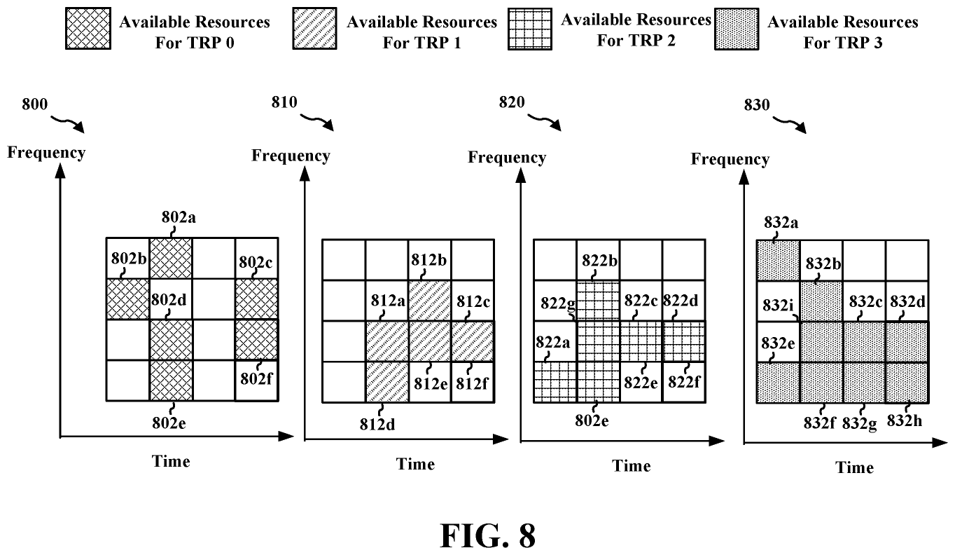

Aspects provided herein enable more efficient resource allocation for multi-TRP sidelink devices. The scheduling flexibility enabled by a per TRP resource determination/resource exclusion may increase system capacity or reduce interference in multi-TRP sidelink communication. FIG. 8 illustrates an example of available resources for a sidelink device having four TRPs. The illustration in FIG. 8 is merely to illustrate the concept and may be applied for different numbers of TRPs. For example, if a UE has M TRPs, M being an integer number, the UE may determine different candidate resources for each of the M TRPs. In some examples, the UE may perform M RSRP measurements for a resource if the UE has M TRPs. The UE may determine available resources upon request for available resource determination, e.g., as part of resource selection for a sidelink transmission.

The UE may decode SCI based on signals received at each TRP (e.g., decoding the SCI individually at each TRP) or may decode the SCI based on signals combined from multiple TRPs. The UE may measure the RSRP individually, such that, each TRP will have an RSRP measurement for a resource. The UE may determine a subset of available resources for each TRP based on the SCI decoding and/or per-TRP RSRP measurement.

A UE, or other sidelink device, may identify a subset of available resources for each TRP. For example, example 800 may illustrate a subset of available resources 802a, 802b, 802c, 802d, 802e, and 802f for a first TRP (TRP 0) of the UE. Example 810 may illustrate a subset of available resources 812a, 812b, 812c, 812d, 812e, and 812f for a second TRP (TRP 1) of the UE. Example 820 may illustrate a subset of available resources 822a, 822b, 822c, 822d, 822e, 822f, and 822g for a third TRP (TRP 2) of the UE. Example 830 may illustrate a subset of available resources 832a, 832b, 832c, 832d, 832e, 832f, 832g, 832h, and 832i for a fourth TRP (TRP 3) of the UE. In some aspects, the UE may report the four subsets of resources 800, 810, 820, and 830 to a higher layer, such as a medium access control (MAC) layer. Each of the sets of resources in the examples 800, 810, 820, and 830 may correspond the same time/frequency grid. For example, if a UE has 4 TRPs covering 4 different directions, the UE may identify, or report, four subsets of available resources for the 4 TRPs (e.g., the available resources shown in each of 800, 810, 820, 830). The UE may provide to a higher layer (e.g., a MAC layer) each of the 4 subsets of available resources corresponding to the 4 TRPs.

In some aspects, if a TB is going to be transmitted using one TRP, for example, a TB that will be transmitted using TRP 1, the resources may be selected from the subset 810 of available resources reported for the corresponding TRP 1 (resources 812a, 812b, 812c, 812d, 812e, and 812f).

In some aspects, if a TB is going to be transmitted using a subset of TRPs, such as TRP 1 and TRP 3, the resources may be selected from a common set (i.e., 810∩830) between the subset 810 of available resources for TRP 1 and resources and the subset 830 of available resources for TRP 3, e.g., the resources 802d, 802e, and 802f (i.e., the resources 832i, 832f, and 832d). For example, a common set of resources may be determined based on the reported subsets of available resources for TRP 1 and TRP 3. Then, the transmission resources may be selected from the common set of available resources.

In some aspects, the higher layer may provide the indices of the subsets of resources 800, 810, 820, and 830 based on a request. For example, the higher layer may indicate that available resource determination and report is requested for TRP 0 and 2. The UE may report two subsets of available resources, each corresponds to one of the two indicated TRPs.

In some aspects, the higher layer may provide the indices of TRPs that subsets of available resources are requested. For example, MAC layer may indicate one of, a subset of, or all of the TRPs that need available resource determination. For example, if a packet to be transmitted using TRP m, MAC layer indicates the UE to report the subset of available resources for TRP m. In another example, if a packet to be transmitted using >1 TRPs, MAC layer may indicate the UE to report subsets of available resources for the >1 TRPs. The UE may determine a subset of available resources for the indicated TRPs. For example, the UE may measure RSRP individually such that each TRP will have an RSRP measurement for a resource. The UE may determine a subset of available resources for the indicated TRPs, based at least on the RSRP measurement. In some aspects, when a resource is determined to be available for the indicated TRP s, the measured RSRPs at the indicated TRPs may all be smaller than the RSRP threshold (common available at the relevant TRPs). In some aspects, RSRP threshold adjustment may be used. For example, the UE may increase RSRP until there are sufficient common available resources at relevant TRPs (e.g., >=20% of total resource). In some aspects, the RSRP threshold may be common to all relevant TRPs and if adjustment is performed, the RSRP threshold may be adjusted for all relevant TRPs.

In some aspects, UE reports each subset of available resources to the higher layer (e.g., MAC layer). In some aspects, the higher layer may select resource for transmission from the subset of available resources. For example, the UE may report each of the available resources 800, 810, 820, 830 to the higher layer. If TRP 1 and TRP 3 will be used for a transmission, the higher layer may select from resources that are commonly available in 810 and 830.

In some aspects, rather than report the subset of available resources for each TRP to the higher layer, the higher layer (e.g., MAC layer) may provide the indices of the TRPs for which available resources are requested. The UE may determine the available resources, e.g., at a lower layer, and may report only the subset of available resources for the indicated TRPS. For example, if a higher layer indicates that the available resources are requested for TRP 0 and TRP 2, the UE may report to the higher layer the subset of available resources shown in 800 for TRP 0 and 820 for TRP 2, e.g., without reporting 810 and 830.

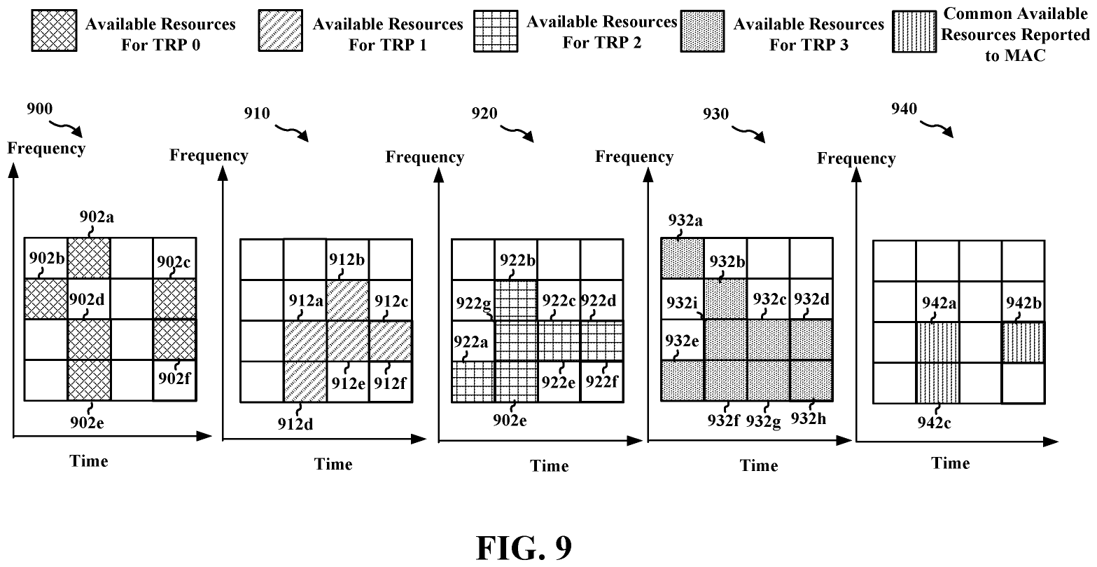

In some examples, the higher layer may provide the indices of the TRPs for which the available resources are requested. The UE may individually measure RSRP at each TRP in order to determine the available resources for the TRP based on the RSRP, as described above. The UE may then determine the subset of resources that are available, in common, to the indicated TRPs (e.g., resources for which the RSRP threshold is smaller than the RSRP threshold for each of the indicated TRPs). The UE may then report the common set of available resources for the indicated TRPs to the higher layer (e.g., MAC layer), and the higher layer may select resources for sidelink transmission from the reported set of available resources. FIG. 9 illustrates an example of resource selection based on available resources for a UE having four TRPs. The UE may identify a subset of available resources for each TRP. For example, example 900 may illustrate a subset of available resources 902a, 902b, 902c, 902d, 902e, and 902f for a first TRP (TRP 0) of the UE. Example 910 may illustrate a subset of available resources 912a, 912b, 912c, 912d, 912e, and 912f for a second TRP (TRP 1) of the UE. Example 920 may illustrate a subset of available resources 922a, 922b, 922c, 922d, 922e, 922f, and 922g for a third TRP (TRP 2) of the UE. Example 930 may illustrate a subset of available resources 932a, 932b, 932c, 932d, 932e, 932f, 932g, 932h, and 932i for a fourth TRP (TRP 3) of the UE. As one example, the MAC layer may indicate a physical layer to report a subset of available resources for TRP 0 and TRP 2. The UE may accordingly report a subset 940 of commonly available resources 942a, 942b, and 942c for TRP 0 and TRP 2. The MAC layer may select resources from the reported subset 940 of available resources (e.g., 942a, 942b, and 942c). In some examples, an RSRP threshold adjustment may be applied to reach a particular amount of available resources. The RSRP threshold may be increased until there is a sufficient amount of common available resources for the indicated TRPs. The threshold amount of available resources may be, e.g., 20% or another threshold percentage of the resources. If the available resources in common to the identified TRPs is less than 20%, the RSRP threshold may be raised in common for each of the identified TRPs.

The report of the available resources to the higher layer may be referred to as a physical (PHY) layer report, in some examples.

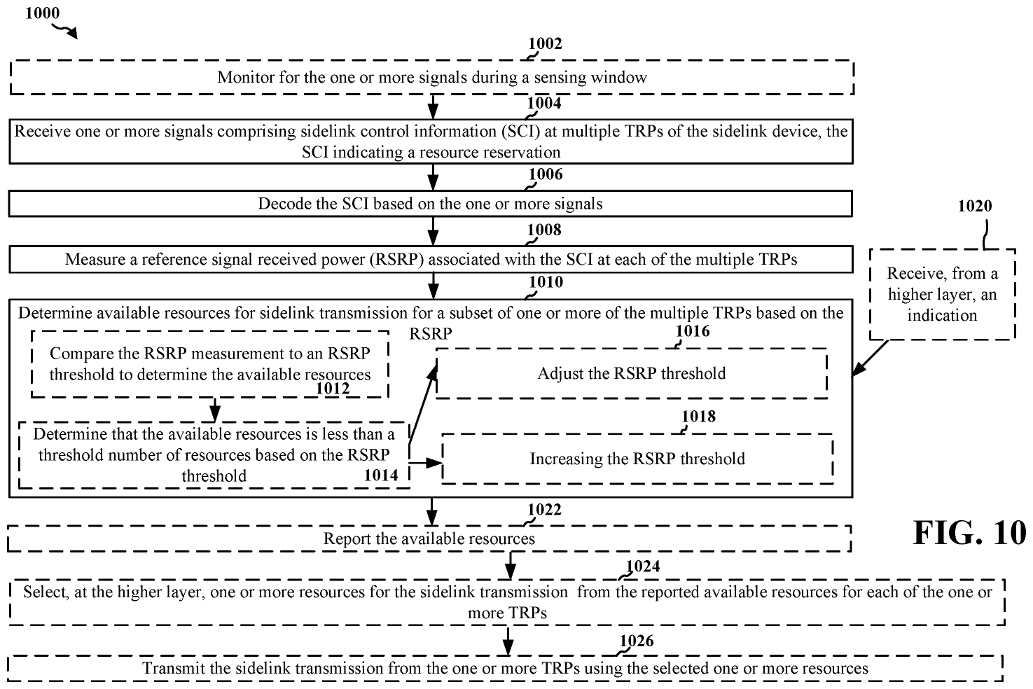

FIG. 10 is a flowchart 1000 of a method of wireless communication. The method may be performed by a multi-TRP sidelink device, such as a UE, an RSU, etc. For example, the method may be performed by the UE 104; the apparatus 1102. Optional aspects are illustrated with a dashed line. The method may enable more efficient resources usage for sidelink communications.

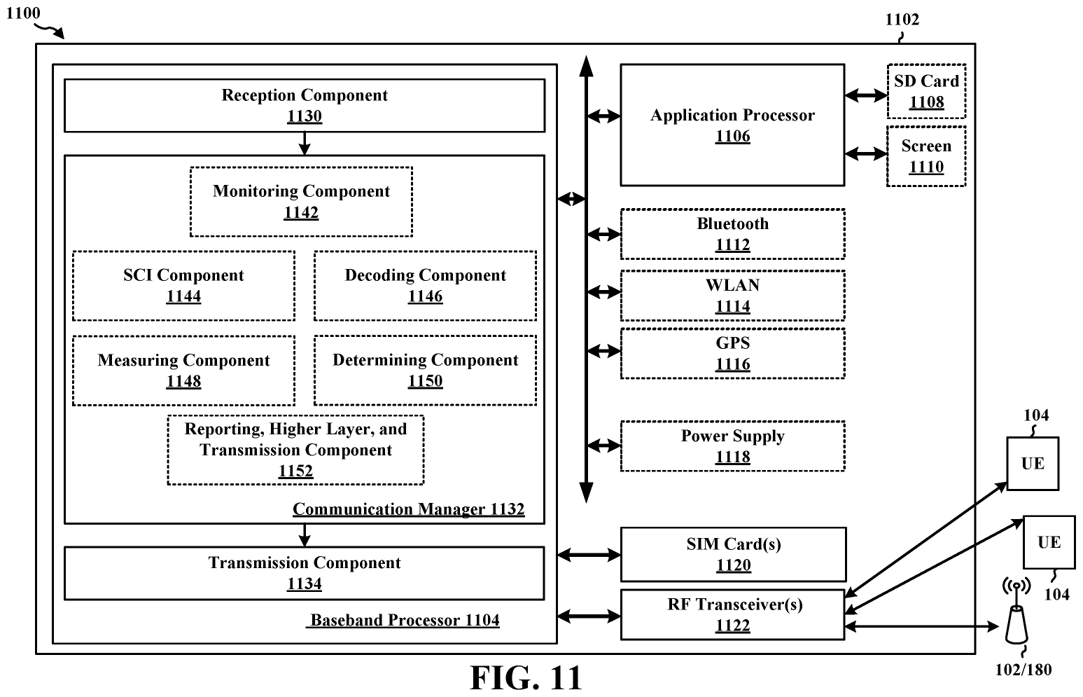

At 1002, the sidelink device may monitor for the one or more signals during a sensing window prior to receiving the one or more signals. For example, 1002 may be performed by monitoring component 1142 in FIG. 11. In some aspects, the sensing window may be similar to the sensing widow 502 illustrated in FIG. 5

At 1004, the sidelink device may receive one or more signals comprising SCI at multiple TRPs of the sidelink device, the SCI indicating a resource reservation. For example, 1004 may be performed by SCI component 1144 in FIG. 11. In some aspects, the signals comprising SCI may be similar to the signals 510 and 512 illustrated in FIG. 5.

At 1006, the sidelink device may decode the SCI based on the one or more signals. For example, 1006 may be performed by decoding component 1146 in FIG. 11. In some aspects, the decoding comprises blind decoding. In some aspects, decoding the SCI based on the one or more signals comprises decoding the one or more signals received at each of the multiple TRPs separately. In some aspects, decoding the SCI based on the one or more signals comprises combining and decoding the one or more signals received at each of the multiple TRPs.

At 1008, the sidelink device may measure a RSRP associated with the SCI at each of the multiple TRPs. For example, 1008 may be performed by measuring component 1148 in FIG. 11.

At 1010, the sidelink device may determine available resources for sidelink transmission for a subset of one or more of the multiple TRPs based on the RSRP. For example, 1010 may be performed by determining component 1150 in FIG. 11. In some aspects, determining the available resources for the sidelink transmission includes separately determining the available resources for each of the multiple TRPs based on an RSRP measurement at a corresponding TRP; the available resources may be in a future resource selection window. In some aspects, the sidelink device determines the available resources for the sidelink transmission further based on SCI decoding.

In some aspects, as part of 1010, at 1012, the sidelink device may compare the RSRP measurement to an RSRP threshold to determine the available resources. In some aspects, the sidelink device may compare the RSRP measurement at the corresponding TRP to an RSRP threshold to determine the available resources for the corresponding TRP. In some aspects, at 1020, the sidelink device may receive, from a higher layer, an indication indicating one or more TRPs of the multiple TRPs. In some aspects, the sidelink device may compare the RSRP measurement at each of the one or more TRPs indicated by the higher layer to an RSRP threshold to determine the available resources for a corresponding TRP. In some aspects, the indication indicates a single TRP, and wherein the available resources for the single TRP are reported to the higher layer in response to the indication from the higher layer. In some aspects, the indication indicates a subset of two or more TRPs and the available resources that are commonly available for the subset of two or more TRPs are reported to the higher layer.

In some aspects, as part of 1010, at 1014, the sidelink device may determine that the available resources is less than a threshold number of resources based on the RSRP threshold. In some aspects, as part of 1010, at 1014, the sidelink device may determine that the available resources for a single TRP is less than a threshold number of resources based on the RSRP threshold. In some aspects, the sidelink device applies a TRP specific RSRP threshold for each of the multiple TRPs. In some aspects, the RSRP threshold is common to each of the multiple TRPs. In some aspects, the RSRP threshold is common to each TRP of the one or more TRPs indicated by the higher layer. In some aspects, as part of 1010, at 1016, the sidelink device may adjust the RSRP threshold for the single TRP.

In some aspects, as part of 1010, at 1018, the sidelink device may increase the first RSRP threshold until the available resources for the one or more TRPs indicated by the higher layer meets the resource threshold. In some aspects, the indication indicates a single TRP, and wherein the available resources for the single TRP are reported to the higher layer in response to the indication from the higher layer.

At 1022, the sidelink device may report the available resources. For example, 1022 may be performed by reporting, higher layer, and transmission component 1152 in FIG. 11. In some aspects, the sidelink device may report the available resources for each of the multiple TRPs to a higher layer. In some aspects, the sidelink device may report the available resources for each of the multiple TRPs to a higher layer. In some aspects, the sidelink device may report to the higher layer, based on the indication, the available resources of the one or more TRPs. In some aspects, the sidelink device may report the available resources that are commonly available for each of the one or more TRP indicated by the higher layer.

At 1024, the sidelink device may select, at the higher layer, one or more resources for the sidelink transmission from the reported available resources for each of the one or more TRPs. For example, 1022 may be performed by reporting, higher layer, and transmission component 1152 in FIG. 11. In some aspects, the sidelink device selects a single TRP for the sidelink transmission and selects the one or more resources from the available resources for the single TRP. In some aspects, the sidelink device selects a subset of two or more TRPs for the sidelink transmission and selects the one or more resources that are common in the available resources of the subset of two or more TRPs. In some aspects, the higher layer comprises a MAC layer.

At 1026, the sidelink device may transmit the sidelink transmission from the one or more TRPs using the selected one or more resources. For example, 1022 may be performed by reporting, higher layer, and transmission component 1152 in FIG. 11.

FIG. 11 is a diagram 1100 illustrating an example of a hardware implementation for an apparatus 1102. The apparatus 1102 is a sidelink device, such as a UE and includes a baseband processor 1104 (also referred to as a modem) coupled to a RF transceiver 1122 and one or more subscriber identity modules (SIM) cards 1120, an application processor 1106 coupled to a secure digital (SD) card 1108 and a screen 1110, a Bluetooth module 1112, a wireless local area network (WLAN) module 1114, a Global Positioning System (GPS) module 1116, and a power supply 1118. The baseband processor 1104 communicates through the RF transceiver 1122 with the UE 104 and/or BS 102/180. In some examples, the baseband processor 1104 may comprise a cellular baseband processor, and the RF transceiver 1122 may comprise a cellular RF transceiver. The baseband processor 1104 may include a computer-readable medium/memory. The computer-readable medium/memory may be non-transitory. The baseband processor 1104 is responsible for general processing, including the execution of software stored on the computer-readable medium/memory. The software, when executed by the baseband processor 1104, causes the baseband processor 1104 to perform the various functions described supra. The computer-readable medium/memory may also be used for storing data that is manipulated by the baseband processor 1104 when executing software. The baseband processor 1104 further includes a reception component 1130, a communication manager 1132, and a transmission component 1134. The communication manager 1132 includes the one or more illustrated components. The components within the communication manager 1132 may be stored in the computer-readable medium/memory and/or configured as hardware within the baseband processor 1104. The baseband processor 1104 may be a component of the device 350 and may include the memory 360 and/or at least one of the TX processor 368, the RX processor 356, and the controller/processor 359. In one configuration, the apparatus 1102 may be a modem chip and include just the baseband processor 1104, and in another configuration, the apparatus 1102 may be the entire wireless device (e.g., see 350 of FIG. 3) and include the additional modules of the apparatus 1102.

The communication manager 1132 includes a monitoring component 1142 that may monitor for the one or more signals during a sensing window prior to receiving the one or more signals, e.g., as described in connection with 1002 in FIG. 10. The communication manager 1132 may further include an SCI component 1144 that may receive one or more signals comprising SCI at multiple TRPs of the sidelink device, the SCI indicating a resource reservation, e.g., as described in connection with 1004 in FIG. 10. The communication manager 1132 may further include a decoding component 1146 that may decode the SCI based on the one or more signals, e.g., as described in connection with 1006 in FIG. 10. The communication manager 1132 may further include a measuring component 1148 that may measure a RSRP associated with the SCI at each of the multiple TRPs, e.g., as described in connection with 1008 in FIG. 10. The communication manager 1132 may further include a determining component 1150 that may determine available resources for sidelink transmission for a subset of one or more of the multiple TRPs based on the RSRP, e.g., as described in connection with 1010-1018 in FIG. 10. For example, the determining component 1150 may compare the RSRP measurement at the corresponding TRP to an RSRP threshold to determine the available resources for the corresponding TRP. The determining component 1150 may determine that the available resources for a single TRP is less than a threshold number of resources based on the RSRP threshold. The determining component 1150 may adjust the RSRP threshold for the single TRP. The determining component 1150 may compare the RSRP measurement at each of the one or more TRPs indicated by the higher layer to an RSRP threshold to determine the available resources for a corresponding TRP. The determining component 1150 may determine that available resources for of the one or more TRPs is less than a resource threshold based on a first RSRP threshold. The determining component 1150 may increase the first RSRP threshold until the available resources for the one or more TRPs indicated by the higher layer meets the resource threshold. The communication manager 1132 may further include a reporting, higher layer, and transmission component 1152 that may report the available resources, e.g., as described in connection with 1020-1026 in FIG. 10. In some aspects, the reporting, higher layer, and transmission component 1152 may report the available resources for each of the multiple TRPs to a higher layer. In some aspects, the reporting, higher layer, and transmission component 1152 may select one or more TRPs for the sidelink transmission. In some aspects, the reporting, higher layer, and transmission component 1152 may select, at the higher layer, one or more resources for the sidelink transmission from the reported available resources for each of the one or more TRPs. In some aspects, the reporting, higher layer, and transmission component 1152 may transmit the sidelink transmission from the one or more TRPs using the selected one or more resources. In some aspects, the reporting, higher layer, and transmission component 1152 may receive, from a higher layer, an indication indicating one or more TRPs of the multiple TRPs. In some aspects, the reporting, higher layer, and transmission component 1152 may report to the higher layer, based on the indication, the available resources of the one or more TRPs. In some aspects, the reporting, higher layer, and transmission component 1152 may receive, from a higher layer, an indication indicating one or more TRPs of the multiple TRPs. In some aspects, the reporting, higher layer, and transmission component 1152 may report the available resources that are commonly available for each of the one or more TRP indicated by the higher layer.

The apparatus may include additional components that perform each of the blocks of the algorithm in the aforementioned flowchart of FIG. 10. As such, each block in the aforementioned flowcharts of FIG. 10 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1102, and in particular the baseband processor 1104, includes means for receiving one or more signals comprising SCI at multiple TRPs of the sidelink device, the SCI indicating a resource reservation. The baseband processor 1104 may further include means for decoding the SCI based on the one or more signals. The baseband processor 1104 may further include means for measuring a RSRP associated with the SCI at each of the multiple TRPs. The baseband processor 1104 may further include means for determining available resources for sidelink transmission for a subset of one or more of the multiple TRPs based on the RSRP. The baseband processor 1104 may further include means for comparing the RSRP measurement at the corresponding TRP to an RSRP threshold to determine the available resources for the corresponding TRP. The baseband processor 1104 may further include means for determining that the available resources for a single TRP is less than a threshold number of resources based on the RSRP threshold. The baseband processor 1104 may further include means for adjusting the RSRP threshold for the single TRP. The baseband processor 1104 may further include means for reporting the available resources for each of the multiple TRPs to a higher layer. The baseband processor 1104 may further include means for selecting one or more TRPs for the sidelink transmission. The baseband processor 1104 may further include means for selecting, at the higher layer, one or more resources for the sidelink transmission from the reported available resources for each of the one or more TRPs. The baseband processor 1104 may further include means for transmitting the sidelink transmission from the one or more TRPs using the selected one or more resources. The baseband processor 1104 may further include means for receiving, from a higher layer, an indication indicating one or more TRPs of the multiple TRPs. The baseband processor 1104 may further include means for reporting to the higher layer, based on the indication, the available resources of the one or more TRPs. The baseband processor 1104 may further include means for receiving, from a higher layer, an indication indicating one or more TRPs of the multiple TRPs. The baseband processor 1104 may further include means for reporting the available resources that are commonly available for each of the one or more TRP indicated by the higher layer. The baseband processor 1104 may further include means for comparing the RSRP measurement at each of the one or more TRPs indicated by the higher layer to an RSRP threshold to determine the available resources for a corresponding TRP. The baseband processor 1104 may further include means for determining that available resources for of the one or more TRPs is less than a resource threshold based on a first RSRP threshold. The baseband processor 1104 may further include means for increasing the first RSRP threshold until the available resources for the one or more TRPs indicated by the higher layer meets the resource threshold. The baseband processor 1104 may further include means for prior to receiving the one or more signals, monitoring for the one or more signals during a sensing window. The aforementioned means may be one or more of the aforementioned components of the apparatus 1102 configured to perform the functions recited by the aforementioned means. As described supra, the apparatus 1102 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

The following example aspects are illustrative only and may be combined with other or teachings described herein, without limitation.

Aspect 1 is method of wireless communication at a multi-TRPs sidelink device, comprising: receiving one or more signals comprising SCI at multiple TRPs of the sidelink device, the SCI indicating a resource reservation; decoding the SCI based on the one or more signals; measuring a RSRP associated with the SCI at each of the multiple TRPs; and determining available resources for sidelink transmission for a subset of one or more of the multiple TRPs based on the RSRP.

Aspect 2 is the method of aspect 1, wherein determining the available resources for the sidelink transmission includes separately determining the available resources for each of the multiple TRPs based on an RSRP measurement at a corresponding TRP, wherein the available resources are in a future resource selection window.

Aspect 3 is the method of any of aspects 1-2, wherein decoding the SCI based on the one or more signals comprises decoding the one or more signals received at each of the multiple TRPs separately.

Aspect 4 is the method of any of aspects 1-2, wherein decoding the SCI based on the one or more signals comprises combining and decoding the one or more signals received at each of the multiple TRPs.

Aspect 5 is the method of any of aspects 1-3, wherein the sidelink device determines the available resources for the sidelink transmission further based on SCI decoding.

Aspect 6 is the method of any of aspects 1-5, further comprising: comparing the RSRP measurement at the corresponding TRP to an RSRP threshold to determine the available resources for the corresponding TRP.

Aspect 7 is the method of any of aspects 1-6, further comprising: determining that the available resources for a single TRP is less than a threshold number of resources based on the RSRP threshold; and adjusting the RSRP threshold for the single TRP.

Aspect 8 is the method of any of aspects 1-7, wherein the sidelink device applies a TRP specific RSRP threshold for each of the multiple TRPs.

Aspect 9 is the method of any of aspects 1-8, wherein the RSRP threshold is common to each of the multiple TRPs.

Aspect 10 is the method of any of aspects 1-9, further comprising: reporting the available resources for each of the multiple TRPs to a higher layer.

Aspect 11 is the method of any of aspects 1-10, further comprising: selecting one or more TRPs for the sidelink transmission; selecting, at the higher layer, one or more resources for the sidelink transmission from the reported available resources for each of the one or more TRPs; and transmitting the sidelink transmission from the one or more TRPs using the selected one or more resources.

Aspect 12 is the method of any of aspects 1-11, wherein the sidelink device selects a single TRP for the sidelink transmission and selects the one or more resources from the available resources for the single TRP.

Aspect 13 is the method of any of aspects 1-11, wherein the sidelink device selects a subset of two or more TRPs for the sidelink transmission and selects the one or more resources that are common in the available resources of the subset of two or more TRPs.

Aspect 14 is the method of any of aspects 1-13, wherein the higher layer comprises a MAC layer.

Aspect 15 is the method of any of aspects 1-14, further comprising: receiving, from a higher layer, an indication indicating one or more TRPs of the multiple TRPs; and reporting to the higher layer, based on the indication, the available resources of the one or more TRPs.

Aspect 16 is the method of any of aspects 1-15, further comprising: receiving, from a higher layer, an indication indicating one or more TRPs of the multiple TRPs; and reporting the available resources that are commonly available for each of the one or more TRP indicated by the higher layer.

Aspect 17 is the method of any of aspects 1-16, wherein the indication indicates a single TRP, and wherein the available resources for the single TRP are reported to the higher layer in response to the indication from the higher layer.

Aspect 18 is the method of any of aspects 1-17, wherein the indication indicates a subset of two or more TRPs and the available resources that are commonly available for the subset of two or more TRPs are reported to the higher layer.

Aspect 19 is the method of any of aspects 1-18, further comprising: comparing the RSRP measurement at each of the one or more TRPs indicated by the higher layer to an RSRP threshold to determine the available resources for a corresponding TRP.

Aspect 20 is the method of any of aspects 1-19, wherein the RSRP threshold is common to each TRP of the one or more TRPs indicated by the higher layer.

Aspect 21 is the method of any of aspects 1-20, further comprising: determining that available resources for of the one or more TRPs is less than a resource threshold based on a first RSRP threshold; and increasing the first RSRP threshold until the available resources for the one or more TRPs indicated by the higher layer meets the resource threshold.

Aspect 22 is the method of any of aspects 1-21, wherein the decoding comprises blind decoding.

Aspect 23 is the method of any of aspects 1-22, further comprising: prior to receiving the one or more signals, monitoring for the one or more signals during a sensing window.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication at a multi-transmission and reception points (TRPs) sidelink device, comprising:
receiving one or more signals comprising sidelink control information (SCI) at multiple TRPs of the sidelink device, the SCI indicating a resource reservation;
decoding the SCI based on the one or more signals;
measuring a reference signal received power (RSRP) associated with the SCI at each of the multiple TRPs; and
determining available resources for sidelink transmission for a subset of one or more of the multiple TRPs based on the RSRP.

2. The method of claim 1, wherein determining the available resources for the sidelink transmission includes separately determining the available resources for each of the multiple TRPs based on an RSRP measurement at a corresponding TRP, wherein the available resources are in a future resource selection window.

3. The method of claim 2, wherein decoding the SCI based on the one or more signals comprises decoding the one or more signals received at each of the multiple TRPs separately.

4. The method of claim 2, wherein decoding the SCI based on the one or more signals comprises combining and decoding the one or more signals received at each of the multiple TRPs.

5. The method of claim 2, wherein the sidelink device determines the available resources for the sidelink transmission further based on SCI decoding.

6. The method of claim 2, further comprising:
comparing the RSRP measurement at the corresponding TRP to an RSRP threshold to determine the available resources for the corresponding TRP.

7. The method of claim 6, further comprising:
determining that the available resources for a single TRP is less than a threshold number of resources based on the RSRP threshold; and
adjusting the RSRP threshold for the single TRP.

8. The method of claim 7, wherein the sidelink device applies a TRP specific RSRP threshold for each of the multiple TRPs.

9. The method of claim 6, wherein the RSRP threshold is common to each of the multiple TRPs.

10. The method of claim 2, further comprising:
reporting the available resources for each of the multiple TRPs to a higher layer.

11. The method of claim 10, further comprising:
selecting one or more TRPs for the sidelink transmission;
selecting, at the higher layer, one or more resources for the sidelink transmission from the reported available resources for each of the one or more TRPs; and
transmitting the sidelink transmission from the one or more TRPs using the selected one or more resources.

12. The method of claim 11, wherein the sidelink device selects a single TRP for the sidelink transmission and selects the one or more resources from the available resources for the single TRP.

13. The method of claim 11, wherein the sidelink device selects a subset of two or more TRPs for the sidelink transmission and selects the one or more resources that are common in the available resources of the subset of two or more TRPs.

14. The method of claim 10, wherein the higher layer comprises a medium access control (MAC) layer.

15. The method of claim 1, further comprising:
receiving, from a higher layer, an indication indicating one or more TRPs of the multiple TRPs; and
reporting to the higher layer, based on the indication, the available resources of the one or more TRPs.

16. The method of claim 1, further comprising:
receiving, from a higher layer, an indication indicating one or more TRPs of the multiple TRP s; and
reporting the available resources that are commonly available for each of the one or more TRP indicated by the higher layer.

17. The method of claim 16, wherein the indication indicates a single TRP, and wherein the available resources for the single TRP are reported to the higher layer in response to the indication from the higher layer.

18. The method of claim 11, wherein the indication indicates a subset of two or more TRPs and the available resources that are commonly available for the subset of two or more TRPs are reported to the higher layer.

19. The method of claim 16, further comprising:
comparing the RSRP measurement at each of the one or more TRPs indicated by the higher layer to an RSRP threshold to determine the available resources for a corresponding TRP.

20. The method of claim 19, wherein the RSRP threshold is common to each TRP of the one or more TRPs indicated by the higher layer.

21. The method of claim 20, further comprising:
determining that available resources for of the one or more TRPs is less than a resource threshold based on a first RSRP threshold; and
increasing the first RSRP threshold until the available resources for the one or more TRPs indicated by the higher layer meets the resource threshold.

22. The method of claim 1, wherein the decoding comprises blind decoding.

23. The method of claim 1, further comprising:
prior to receiving the one or more signals, monitoring for the one or more signals during a sensing window.

24. An apparatus for wireless communication at a multi-transmission and reception points (TRPs) sidelink device, comprising:
a memory; and
at least one processor coupled to the memory and configured to:
receive one or more signals comprising sidelink control information (SCI) at multiple TRPs of the sidelink device, the SCI indicating a resource reservation;
decode the SCI based on the one or more signals;
measure a reference signal received power (RSRP) associated with the SCI at each of the multiple TRPs; and
determine available resources for sidelink transmission for a subset of one or more of the multiple TRPs based on the RSRP.

25. An apparatus for wireless communication at a multi-transmission and reception points (TRPs) sidelink device, comprising:
means for receiving one or more signals comprising sidelink control information (SCI) at multiple TRPs of the sidelink device, the SCI indicating a resource reservation;
means for decoding the SCI based on the one or more signals;
means for measuring a reference signal received power (RSRP) associated with the SCI at each of the multiple TRPs; and
means for determining available resources for sidelink transmission for a subset of one or more of the multiple TRPs based on the RSRP.

26. A computer-readable medium storing computer executable code at a multi-transmission and reception points (TRPs) sidelink device, the code when executed by a processor cause the processor to:
receive one or more signals comprising sidelink control information (SCI) at multiple TRPs of the sidelink device, the SCI indicating a resource reservation;
decode the SCI based on the one or more signals;
measure a reference signal received power (RSRP) associated with the SCI at each of the multiple TRPs; and
determine available resources for sidelink transmission for a subset of one or more of the multiple TRPs based on the RSRP.
